(19) United States
(12) Patent Application Publication
(10) Pub. No.: US 2010/0240839 A1
(43) Pub. Date: Sep. 23, 2010

(54) BLOCK COPOLYMERS OF POLYETHYLENE TEREPHTHALATE AND OF THE POLYAMIDE COMPOSED OF META-XYLYLENEDIAMINE AND ADIPIC ACID

(75) Inventors: Joachim Strauch, Haltern (DE); Paul-Michael Bever, Neustadt (DE); Freddy Gruber, Offenbach (DE); Volker Warzelhan, Weisenheim (DE); Bernhard Rosenau, Neustadt (DE)

Correspondence Address: CONNOLLY BOVE LODGE & HUTZ LLP, 1875 EYE STREET, N.W., SUITE 1100, WASHINGTON, DC, 20006, US

(73) Assignee: BASF AKTIENGESELLSCHAFT, Ludwigshafen (DE)

(21) Appl. No.: 11/721,073

(22) PCT Filed: Dec. 3, 2005
(86) PCT No.: PCT/EP05/12983

§ 371 Date: Jun. 7, 2007

(30) Foreign Application Priority Data
Dec. 9, 2004 (DE) 10 2004 059 597.6

(51) Int. Cl. C08G 63/91; C08L 67/02; C08L 77/10

(52) U.S. Cl. 525/425

(57) ABSTRACT

Process for preparation of block polymers of polyethylene terephthalate and of the polyamide composed of meta-xylylenediamine and adipic acid, and process for their preparation.

The present invention relates to block copolymers of polyethylene terephthalate and of the polyamide composed of meta-xylylenediamine and adipic acid, and also to a process for their preparation.

EP-A-1 200 522 discloses a process for preparation of polymeric mixtures (blends) of polyethylene terephthalate and of the fully condensed polyamide composed of meta-xylylenediamine and adipic acid. These mixtures are not fully satisfactory in containers produced therefrom.

An object on which the present invention was based was therefore to eliminate the abovementioned disadvantages.

Accordingly, block copolymers of polyethylene terephthalate and of the polyamide composed of meta-xylylenediamine and adipic acid have been found. A novel and improved process for preparation of block copolymers of polyethylene terephthalate and of the polyamide composed of meta-xylylenediamine and adipic acid has also been found, which comprises adding at a relative solution viscosity of from 1.5 to 2.2 polyethylene terephthalate at a pressure of from 0.1 to 20 bar and at a temperature of from 245 to 300° C.

The inventive process can be conducted as follows:

Conventional methods can be used to carry out the condensation of meta-xylylenediamine [3-(aminomethyl)benzylamine] and adipic acid, examples being disclosed in Ullmanns Encyklopädie der Technischen Chemie [Ullmann's Encyclopedia of Industrial Chemistry], 4th edition, Vol. 19, pp. 39-54, Verlag Chemie, Weinheim 1980, and Ullmanns Encyclopedia of Industrial Chemistry, Vol. A21, pp. 179-206, VCH Verlag, Weinheim 1992, and Stoeckhert, Kunststofflexikon [Plastics encyclopedia], 8th edition, pp. 425-428, Hanser Verlag Munich 1992 (keyword “Polyamide” [Polyamides] et seq.). The components meta-xylylenediamine, adipic acid, and water may preferably be reacted separately or in the form of any desired mixture, preferably in the form of a mixture of all three of the components, batchwise or preferably continuously at a pressure of from 2 to 20 bar, preferably from 5 to 15 mbar, particularly preferably from 7 to 12 bar, and at a temperature of from 170 to 280° C., preferably from 180 to 270° C., particularly preferably from 190 to 260° C., in particular from 200 to 250° C. Preferred starting mixtures are from 30 to 80% strength by weight solutions of the salt compound composed of meta-xylylenediamine and adipic acid, in particular from 45 to 70% strength by weight solutions. Once the mixture has been heated to a target pressure and temperature, the water is removed by distillation.

Post-condensation can then be carried out, or molten polyamide directly, preferably post-condensation at a pressure of from 0.1 to 3 bar, preferably from 0.5 to 2 bar, particularly preferably from 0.7 to 1.5 bar, in particular at atmospheric pressure under an inert gas, such as nitrogen or argon, preferably nitrogen, and at a temperature of from 240 to 300° C., preferably from 250 to 290° C., particularly preferably from 260 to 280° C.

The addition of the polyethylene terephthalate to the polyamide can generally be carried out at a pressure of from 0.1 to 20 bar and at a temperature of from 240 to 300° C., preferably from 245 to 300° C. In one preferred embodiment, the addition of the polyethylene terephthalate takes place during the process to prepare the polyamide.

After the reaction, the block copolymer may be finished via processes known per se, for example via underwater bead pelletization, underwater strand pelletization, or other forms of strand pelletization. The resultant pellets can be subjected to an extraction process, which may take place either continuously or else batchwise. Suitable extractants, inter alia, are water and C₁-C₈ alkanols, such as ethanol and methanol, preferably water. The extracted block copolymer may be subjected to solid-phase condensation in a further step. This may be carried out either in vacuo or else under an inert gas, such as nitrogen or argon, preferably nitrogen. The temperature here may vary widely, but is generally from 120 to 230° C., preferably from 130 to 210° C., and particularly preferably from 140 to 190° C.

The ratio by weight of polyethylene terephthalate to the polyamide can be varied widely, but is generally from 0.001:1 to 1000:1, preferably from 0.005:1 to 500:1, particularly preferably from 0.001:1 to 100:1. In one preferred embodiment, the ratio by weight of polyethylene terephthalate to the polyamide is generally from 0.002:1 to 0.1:1, preferably from 0.002:1 to 0.08:1, particularly preferably from 0.003:1 to 0.07:1.

The molar ratio of meta-xylylenediamine to adipic acid can be varied widely, but is generally from 1.5:1 to 0.75:1, preferably from 1.2:1 to 0.8:1, particularly preferably from 1.1:1 to 0.9:1 or equimolar (1:1), in particular from 1.05:1 to 0.95:1.

In the event that the intention is to improve haze, the molar ratio of meta-xylylenediamine to adipic acid is generally from 1.5:1 to 1:1, preferably from 1.2:1 to 1.01:1, particularly preferably from 1.1:1 to 1.02:1, in particular from 1.05:1 to 1.01:1.

In the event that the intention is to improve color number, the molar ratio of adipic acid to meta-xylylenediamine is generally from 1.5:1 to 1:1, preferably from 1.2:1 to 1.01:1, particularly preferably from 1.1:1 to 1.02:1, in particular from 1.05:1 to 1.01:1.

In one embodiment of the condensation of meta-xylylenediamine and adipic acid, the polycondensation processes can be carried out batchwise in a steel autoclave at a pressure of from 1 to 20 bar. The starting materials here may be used in a solution of strength from 30 to 80% by weight in water.

In another embodiment, the polycondensation processes can be carried out continuously at a pressure of from 1 to 20 bar. The polycondensation system here can be composed of a makeup vessel, boiler reactor, separator, and pelletizor. The starting materials may be used in a solution of strength from 30 to 80% by weight in water.

The content of residue monomer in the inventive block copolymer is generally up to 500 ppm, for example from 0.1 to 500 ppm, preferably from 0.5 to 50 ppm, particularly preferably from 1 to 15 ppm, of meta-xylylenediamine. The content of residue adipic acid monomer is generally below 10 ppm. The content of cyclic dimer (MXDA+adipic acid) in the inventive block copolymer is generally up to 1500 ppm, for example from 10 to 1500 ppm, preferably from 50 to 1000 ppm, particularly preferably from 100 to 250 ppm.

Polyamides generally suitable are any of the polyamides, and generally those composed of from 50 to 100% by weight, preferably from 70 to 100% by weight, particularly preferably from 85 to 100% by weight, of meta-xylylenediamine, and of from 50 to 100% by weight, preferably from 70 to 100% by weight, particularly preferably from 85 to 100% by weight, of adipic acid, and of from 0 to 50% by weight, preferably from 0 to 30% by weight, particularly preferably from 0 to 15% by weight, of the appropriate comonomers and/or, if appropriate, chain regulators, and/or, if appropriate, stabilizers, with molecular weight Mn of from 10 000 to 50 000, preferably high-molecular-weight polyamides with molecular weight Mn of from 30 000 to 40 000, or low-molecular-weight polyamides with molecular weight Mn of from 11 000 to 22 000, particularly preferably low-molecular-weight polyamides with molecular weight Mn of from 13 000 to 20 000, in particular low-molecular-weight polyamides with molecular weight Mn of from 15 000 to 19 000.

The molar mass is determined via GPC by analogy with DIN 55672-1, using an apparatus composed of a Kontron Instruments 420 HPLC pump, a Gilson Abimed autosampler, a Gamma Analysentechnik LCD UV photometer (230/D), and an Agilent G1362A differential refractometer. The eluent utilized comprised a mixture of hexafluoroisopropanol and 0.05% of potassium trifluoroacetate. The Polymer Laboratories columns used were respectively an HFIP gel preliminary column (internal diameter: 7.5 mm, length 5 cm) and a HFIP gel linear column (internal diameter: 7.5 mm, length 5 cm). The column temperature was 40° C. and the flow rate was 0.5 ml/min. The specimens with density 1.5 g/l were pre-filtered through Millipore Millex FG (pore width 0.2 [μm]). PMMA standards from PSS were used for calibration.

The relative solution viscosity is generally from 1.5 to 2.2, preferably from 1.55 to 2.1, particularly preferably from 1.6 to 2, in particular from 1.65 to 1.8.

The relative solution viscosity of the polyamide was determined using specimens of 1 g of polyamide in 100 ml of 96% strength by weight sulfuric acid, and the measurement was carried out with the aid of a 50120 (Schott) Ubbelohde viscosimeter 2 to DIN EN ISO 1628-1.

Examples of suitable comonomers for the meta-xylylenediamine are aliphatic, aromatic, or arylaliphatic diamines, e.g. ethylenediamine, butylenediamine, pentamethylenediamine, hexamethylenediamine, cyclohexanediamine, octamethylenediamine, bis(4,4-aminocyclohexyl)methane, bis(4,4-amino-3,3-methyl-cyclohexyl)methane, bis(amino)cyclohexane, para-phenylenediamine, ortho-xylylenediamine and para-xylylenediamine.

Examples of suitable comonomers for the adipic acid are aliphatic, aromatic, or arylaliphatic dicarboxylic acids, e.g. terephthalate acid, isophthalate acid, sulfoisophthalate acid, naphalene-2,6-dicarboxylic acid, cyclohexanedicarboxylic acid, succinic acid, glutaric acid, azelaic acid, and sebacic acid.

Examples of suitable chain regulators are monofunctional regulators, such as triacetonediamine compounds (see WO-A 95/28443), monocarboxylic acids, such as acetic acid, propionic acid, and benzoic acid, and also bases, such as (mono)amines, such as hexylamine or benzylamine, diamines, such as hexamethylenediamine or 1,4-cyclohexanediamine, C₄-C₁₀ dicarboxylic acids, such as adipic acid, azelaic acid, sebacic acid, dodecanedioic acid, C₅-C₈ cycloalkanedicarboxylic acids, such as cyclohexane-1,4-dicarboxylic acid; benzene- and naphthalene dicarboxylic acids, e.g. isophthalic acid, terephthalic acid, and naphthalene-2,6-dicarboxylic acid.

In order to improve the properties of the inventive block copolymers, any of the known additives may be used for modification, e.g. nucleating agents, dies, color pigments, flow improvers, UV-absorbent substances, matting agents, oxygen scavengers, inorganic or organic fillers or impact-modified fillers.

Suitable stabilizers are the following compounds known from the literature: sterically hindered phenols, phosphorus compounds, e.g. the hypophosphites, and mixtures of these two classes of stabilizers.

The polyamides generally comprise from 0 to 1% by weight, preferably from 0.05 to 0.8% by weight, particularly preferably from 0.1 to 0.7% by weight, in particular from 0.3 to 0.6% by weight, of stabilizers.

Polyethylene terephthalates generally suitable are any of the polyethylene terephthalates, and generally those composed of from 50 to 100% by weight, preferably from 70 to 100% by weight, particularly preferably from 85 to 101% by weight, of ethylene glycol, and of from 50 to 100% by weight, preferably from 70 to 100% by weight, particularly preferably from 85 to 100% by weight, of terephthalic acid, and of from 0 to 50% by weight, preferably from 0 to 30% by weight, particularly preferably from 0 to 15% by weight of the appropriate comonomers, with molecular weight Mn of from 10 000 to 50 000, preferably high-molecular-weight polyethylene terephthalates with molecular weight Mn of from 35 000 to 50 000, or low-molecular-weight polyethylene terephthalates with molecular weight Mn of from 10 000 to 25 000, particularly preferably low-molecular-weight polyethylene terephthalates with molecular weight Mn of from 12 000 to 22 000.

Polyethylene terephthalate oligomers are also suitable with molecular weight Mn of from 3000 to 12 000, preferably from 5000 to 12 000, particularly preferably from 10 000 to 12 000. The molar mass determination method is analogous to the determination method for the block copolymers.

Suitable comonomers for the ethylene glycol are triethylene glycol, 1,4-cyclohexanedimethanol, 1,3-propanediol, 1,4-butanediol, 1,5-pentanediol, 1,6-hexanediol, 3-methyl-1,4-pentanediol, 2-methyl-1,4-pentanediol, 2,2,4-trimethyl-1,3-pentanediol, 2-ethyl-1,3-hexanediol, 2,2-diethyl-1,3-propanediol, 1,3-hexanediol, 1,4-dihydroxybenzene, 2,2-bis(4-hydroxycyclohexyl)propane, 2,4-dihydroxy-1,1,3,3-tetramethylcyclobutane, 2,2-bis(3-hydroxyethoxyphenyl)propane, and 2,2-bis(4-hydroxyethoxyphenyl)propane.

Suitable comonomers for the terephthalic acid are adipic acid, isophthalic acid, phthalic acid, 2,6-naphthalenedicarboxylic acid, cyclohexanedicarboxylic acid, succinic acid, glutaric acid, sebacic acid, and azelaic acid.

Other components which may be present in the polyethylene terephthalates in very small amounts of from 0.1 to 5% by weight, preferably from 0.1 to 3% by weight, particularly preferably 0.1 to 2% by weight, are trifunctional or tetrafunctional comonomers, e.g. trimellitic acid or pyromellitic acid, or a mixture of these.

The inventive block copolymers of polyethylene terephthalate and of the polyamide composed of meta-xylylenediamine and adipic acid are suitable for production of, or as starting material for production of, moldings, pipes, profiles, preforms, containers, dishes, fibers, foils, film, bottles, and foams of any type, e.g. via extrusion, injection molding, calendering, blow molding, compression molding, sintering, or other conventional methods of thermoplastics processing.

The preferred use of the inventive block copolymers (of polyethylene terephthalate and polyamide) is preparation of blend mixtures with polyethylene terephthalate. These are particularly suitable for production of transparent, colorless containers and injection moldings, in particular of preforms and bottles for the drinks industry. The amount of block copolymer present in the polyethylene terephthalate in this preferred application is from 0.01 to 15% by weight, preferably from 0.02 to 10% by weight, particularly preferably from 0.03 to 7% by weight.

With a view to possible use in food packaging, the pellets of the block polymers are subjected to an extraction process. This effectively lowers the content of residue polymers.

When the block polymers prepared are mixed with polyethylene terephthalate the result is improved phase compatibility of the polyamide with the polyethylene terephthalate matrix, thus achieving high transparency in subsequent use of these blends for containers, moldings, and foils. At the same time, there is a significant improvement in the undesired yellow coloration.

### EXAMPLES

### Inventive Example 1

### Preparation of a Block Copolymer of a Polyamide Composed of Meta-Xylylenediamine and Adipic Acid and 2% by Weight of Low-Molecular-Weight Polyethylene Terephthalate

2070.4 g (14.17 mol) of adipic acid were used as initial charge in a 10 liter tank, and 1714.1 g (95.12 mol) of water and 1977.1 g (14.52 mol) of meta-xylylenediamine were added, with stirring, and the mixture was heated to a temperature of 220° C. under nitrogen, and the water was removed by distillation at a pressure of 10 bar. After depressurization to atmospheric pressure, post-condensation was carried out for 1 hour at a temperature of 260° C. under nitrogen, 80 g of a low-molecular-weight polyethylene terephthalate (IV=0.6, Mn=18 500, modified by 2 mol % of isophthalic acid) being added at a relative viscosity of 1.65 [after 45 minutes] with an increase in stirring rate (from 80 to 120 rpm), and, after a further 5 minutes and for a period of 10 minutes, the system was evacuated down to 400 mbar and then depressurized. In the next step, the polymer melt was discharged through a water bath and pelletized.

Inherent viscosity (IV) was measured in a mixture of 60% by weight of phenol and 40% by weight of 1,1,2,2-tetrachloroethane at a concentration of 0.5 g/100 ml of solvent.

### Inventive Example 2

### Preparation of a Block Copolymer of a Polyamide Composed of Meta-Xylylenediamine and Adipic Acid and 5% by Weight of Low-Molecular-Weight Polyethylene Terephthalate

The preparation method was analogous to that of the Inventive example 1, but 200 g of a low-molecular-weight polyethylene terephthalate (IV=0.6, Mn=18 500, modified by 2 mol % of isophthalic acid) were used.

### Inventive Example 3

### Preparation of a Block Copolymer of a Polyamide Composed of Meta-Xylylenediamine and Adipic Acid and 1% by Weight of Low-Molecular-Weight Polyethylene Terephthalate

The preparation method was analogous to that of the Inventive example 1, but 40 g of a low-molecular-weight polyethylene terephthalate (IV=0.6, Mn=18 500, modified by 2 mol % of isophthalic acid) were used.

### Inventive Example 4

### Preparation of a Block Copolymer of a Polyamide Composed of Meta-Xylylenediamine and Adipic Acid and 0.5% by Weight of Low-Molecular-Weight Polyethylene Terephthalate

The preparation method was analogous to that of the Inventive example 1, but 20 g of a low-molecular-weight polyethylene terephthalate (IV=0.6, Mn=18 500, modified by 2 mol % of isophthalic acid) were used.

### Comparative Example A

This involves the polyamide MXD6007, which is commercially available from Mitsubishi Gas Chemical.

The results are given in table 1 below:

TABLE 1

| Example | Relative | Amino end | Carboxy end |
|---|---|---|---|
| No. | Viscosity* | group content | group content |
| 1 | 1.856 | 137 | 54 |
| 2 | 1.736 | 141 | 42 |
| 3 | 1.815 | 148 | 38 |
| 4 | 1.765 | 154 | 30 |
| A | 2.671 | 20 | 65 |

*Relative viscosity = specimens of 1 g of polyamide in 100 ml of 96% strength by weight sulfuric acid; measurement with the aid of a Schott 50120 Ubbelohde viscosimeter 2 to DIN EN ISO 1628-1

### Inventive Example I

### Production of Preforms

Homogeneous pellet mixtures were prepared from 95% by weight of Cleartuf© Aqua D82 polyethylene terephthalate pellets from Mossi & Ghisolfi and, in each case, 5% by weight of the inventive and comparative examples mentioned in table 1. These pellet mixtures were then used for injection molding of bottle preforms. Preforms of weight 49 g were produced at a temperature of 275° C. on a single-mold Arburg 320 injection molding machine.

### Inventive Example II

### Production of Bottles

The preforms produced as in Inventive example I were blown at a temperature of 110° C. and at a pressure of 40 bar in the bottle mold of a Sidel SB01 bottle machine to give 1.5 liter bottles.

The results are given in table 2 below:

TABLE 2

| Polymer from example no. | Haze* of bottle [%] |
|---|---|
| 1 | 3.7 |
| 2 | 3.5 |
| A | 12.5 |

*Haze = measurement with the aid of Gardner dual measurement equipment by the ASTM D100392 method

1. A block polymer comprising polyethylene terephthalate and a polyamide comprising meta-xylylenediamine and adipic acid.

2. A process for preparation a block polymer comprising polyethylene terephthalate and a polyamide comprising meta-xylylenediamine and adipic acid, which comprises, adding to the polyamide at a relative solution viscosity of from 1.5 to 2.2, polyethylene terephthalate at a pressure of from 0.1 to 20 bar and at a temperature of from 240 to 300° C.

3. The process for preparation of block polymers of polyethylene terephthalate and of the polyamide comprising meta-xylylenediamine and adipic acid according to claim 2, wherein the polyethylene terephthalate is added at a pressure of from 0.1 to 3 bar and at a temperature of from 260 to 300° C.

4. The process for preparation of block polymers of polyethylene terephthalate and of the polyamide comprising meta-xylylenediamine and adipic acid according to claim 2, wherein the polyethylene terephthalate is added during the process of preparation of the polyamide.

5. The process for preparation of block polymers of polyethylene terephthalate and of the polyamide comprising meta-xylylenediamine and adipic acid according to claim 2, wherein the polyethylene terephthalate is added at atmospheric pressure.

6. The process for preparation of block polymers of polyethylene terephthalate and of the polyamide comprising meta-xylylenediamine and adipic acid according to claim 2, wherein the ratio by weight of polyethylene terephthalate used to the polyamide is from 0.005:1 to 1000:1.

7. The process for preparation of block polymers of polyethylene terephthalate and of the polyamide comprising meta-xylylenediamine and adipic acid according to claim 2, wherein the ratio by weight of polyethylene terephthalate used to the polyamide is from 0.005:1 to 0.1:1.

8. A block polymer prepared from polyethylene terephthalate and from a polyamide comprising meta-xylylenediamine and adipic acid, by adding to the polyamide at a relative solution viscosity of from 1.55 to 2.1, polyethylene terephthalate at a pressure of from 0.1 to 20 bar and at a temperature of from 120 to 300° C.

9. The process for preparation of block polymers of polyethylene terephthalate and of the polyamide comprising meta-xylylenediamine and adipic acid according to claim 3, wherein the polyethylene terephthalate is added during the process of preparation of the polyamide.

10. The process for preparation of block polymers of polyethylene terephthalate and of the polyamide comprising meta-xylylenediamine and adipic acid according to claim 3, wherein the polyethylene terephthalate is added at atmospheric pressure.

11. The process for preparation of block polymers of polyethylene terephthalate and of the polyamide comprising meta-xylylenediamine and adipic acid according to claim 4, wherein the polyethylene terephthalate is added at atmospheric pressure.

12. The process for preparation of block polymers of polyethylene terephthalate and of the polyamide comprising meta-xylylenediamine and adipic acid according to claim 3, wherein the ratio by weight of polyethylene terephthalate used to the polyamide is from 0.005:1 to 1000:1.

13. The process for preparation of block polymers of polyethylene terephthalate and of the polyamide comprising meta-xylylenediamine and adipic acid according to claim 4, wherein the ratio by weight of polyethylene terephthalate used to the polyamide is from 0.005:1 to 1000:1.

14. The process for preparation of block polymers of polyethylene terephthalate and of the polyamide comprising meta-xylylenediamine and adipic acid according to claim 5, wherein the ratio by weight of polyethylene terephthalate used to the polyamide is from 0.005:1 to 1000:1.

15. The process for preparation of block polymers of polyethylene terephthalate and of the polyamide comprising meta-xylylenediamine and adipic acid according to claim 3, wherein the ratio by weight of polyethylene terephthalate used to the polyamide is from 0.005:1 to 0.1:1.

16. The process for preparation of block polymers of polyethylene terephthalate and of the polyamide comprising meta-xylylenediamine and adipic acid according to claim 4, wherein the ratio by weight of polyethylene terephthalate used to the polyamide is from 0.005:1 to 0.1:1.

17. The process for preparation of block polymers of polyethylene terephthalate and of the polyamide comprising meta-xylylenediamine and adipic acid according to claim 5, wherein the ratio by weight of polyethylene terephthalate used to the polyamide is from 0.005:1 to 0.1:1.

18. The process for preparation of block polymers of polyethylene terephthalate and of the polyamide comprising meta-xylylenediamine and adipic acid according to claim 6, wherein the ratio by weight of polyethylene terephthalate used to the polyamide is from 0.005:1 to 0.1:1.
